(19) United States
(12) Patent Application Publication
(10) Pub. No.: US 2023/0401493 A1
(43) Pub. Date: Dec. 14, 2023

(54) SYSTEMS AND METHODS FOR PROVIDING WORKSPACE DISTRIBUTION AND/OR CONFIGURATION RECOMMENDATIONS

(71) Applicant: Dell Products, L.P., Round Rock, TX (US)

(72) Inventors: Gokul Thiruchengode Vajravel, Bangalore (IN); Nikhil Manohar Vichare, Austin, TX (US); Vivek Viswanathan Iyer, Saint Johns, FL (US)

(73) Assignee: Dell Products, L.P., Round Rock, TX (US)

(21) Appl. No.: 17/806,746

(22) Filed: Jun. 14, 2022

(51) Int. Cl. G06Q 10/02

(52) U.S. Cl. CPC G06Q 10/02

(57) ABSTRACT

Systems and methods for generating workspace distribution and/or configuration recommendations are described. In an embodiment, an Information Handling System (IHS) may include a processor and a memory coupled to the processor, the memory having program instructions stored thereon that, upon execution, cause the IHS to: receive data related to a plurality of workspaces; generate, based upon the data, a recommendation to modify at least one of the plurality of workspaces; and modify the at least one of the plurality of workspaces.

### FIELD

This disclosure relates generally to Information Handling Systems, and, more specifically, to systems and methods for providing workspace distribution and/or configuration recommendations.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Systems and methods for providing workspace distribution and/or configuration recommendations are described. In an illustrative, non-limiting embodiment, an Information Handling System (IHS) may include a processor and a memory coupled to the processor, the memory having program instructions stored thereon that, upon execution, cause the IHS to: receive data related to a plurality of workspaces; generate, based upon the data, a recommendation to modify at least one of the plurality of workspaces; and modify the at least one of the plurality of workspaces.

In some cases, each of the plurality of workspaces may be selectable for use via a reservation service. The plurality of workspaces may include at least one of: shared offices, share cubicles, shared desks, or work-from-home spaces.

One or more workspaces among the plurality of workspaces may include a docking station configured to receive a client IHS, and the data may include data obtained by the docking station. Additionally, or alternatively, the data may be received from one or more client IHSs with access to the plurality of workspaces. Additionally, or alternatively, the data may be received from at least one of: a workspace management system, a user profile database, a user experience telemetry service, or a human resources application.

To generate the recommendation, the program instructions, upon execution, may cause the IHS to apply a Machine Learning (ML) or Artificial Intelligence (AI) model to the data. The ML or AI model may include a collaborative filtering model. The recommendation may include a recommendation to increase or decrease a number of workspaces of a selected type among the plurality of workspaces. Additionally, or alternatively, the recommendation may include a recommendation to add or remove a peripheral device to a selected type of workspace among the plurality of workspaces.

The data may include, for a given workspace among the plurality of workspaces, at least one of: an identity of the given workspace, a location of the given workspace, an identification of a docking station of the given workspace, an identification of a peripheral device coupled to a docking station of the given workspace, an identification of a peripheral device coupled to a client IHS in the given workspace, a number of displays in the given workspace, or a booking frequency of the given workspace. To generate the recommendation, the program instructions, upon execution, may cause the IHS to determine, based upon the data, that: (a) in a first location, a first type of workspace is used more than a second type of workspace, and (b) in a second location, the second type of workspace is used more than the first type of workspace, and the recommendation may include an indication to: (a) increase a number of workspaces of the first type in the first location, and (b) increase a number of workspaces of the second type in the second location.

Additionally, or alternatively, the data may include, for a given workspace among the plurality of workspaces, at least one of: an identification of a seat in the given workspace, an identification of a desk in the given workspace, a proximity of the given workspace to a resource shared among two or more workspaces, a usage of the shared resource by the client IHS, an identify of a user of a client IHS in the given workspace, a job title of the user, a persona associated with the user, an experience metric of the user, or a workload executed by the user. To generate the recommendation, the program instructions, upon execution, may cause the IHS to determine, based upon the data, how to maintain an amount of workspaces of a certain type proportional to a number of users of a selected type by increasing or decreasing the amount.

Additionally, or alternatively, the data may include, for a given workspace among the plurality of workspaces, an indication of a collaboration session involving the given workspace. To generate the recommendation, the program instructions, upon execution, may cause the IHS to increase a number of workspaces of a same type as the given workspace within a selected distance from the given workspace.

To modify the at least one of the plurality of workspaces, the program instructions, upon execution, may cause the IHS to instruct a docking station in a given workspace to couple or decouple a peripheral device. Additionally, or alternatively, to modify the at least one of the plurality of workspaces, the program instructions, upon execution, may cause the IHS to instruct a docking station in a given workspace to enable or disable a feature of a peripheral device.

In another illustrative, non-limiting embodiment, a method may include generating, based upon telemetry data, a recommendation to modify at least one of a plurality of workspaces, where the telemetry data comprises at least one of: an identity of a given workspace among the plurality of workspaces, a location of the given workspace, an identification of a peripheral device coupled to a docking station of the given workspace, or a booking frequency of the given workspace; and instructing the docking station to make the peripheral device, or a feature of the peripheral device, available or unavailable to a user of the given workspace based, at least in part, upon the recommendation.

In yet another illustrative, non-limiting embodiment, a memory storage device may have program instructions stored thereon that, upon execution by an IHS, cause the IHS to: receive data comprising at least one of: a proximity of a given workspace among a plurality of workspaces to a resource shared among two or more workspaces, or a usage of the shared resource; and provide, based at least in part upon the data using an ML or AI model, a recommendation to an Information Technology Decision Maker (ITDM) to increase or decrease a number of workspaces among the plurality of workspaces of a same type as the given workspace.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 depicts a block diagram of examples of components of an Information Handling System (IHS), according to some embodiments.

FIG. 2 depicts a block diagram of an example of a system for providing workspace distribution and/or configuration recommendations, according to some embodiments.

FIG. 3 depicts a flowchart of an example of a method for providing workspace recommendations based upon usage, according to some embodiments.

FIG. 4 depicts a flowchart of an example of a method for providing workspace recommendations based upon personas and preferences, according to some embodiments.

FIG. 5 depicts a flowchart of an example of a method for providing workspace recommendations based upon collaboration activities, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

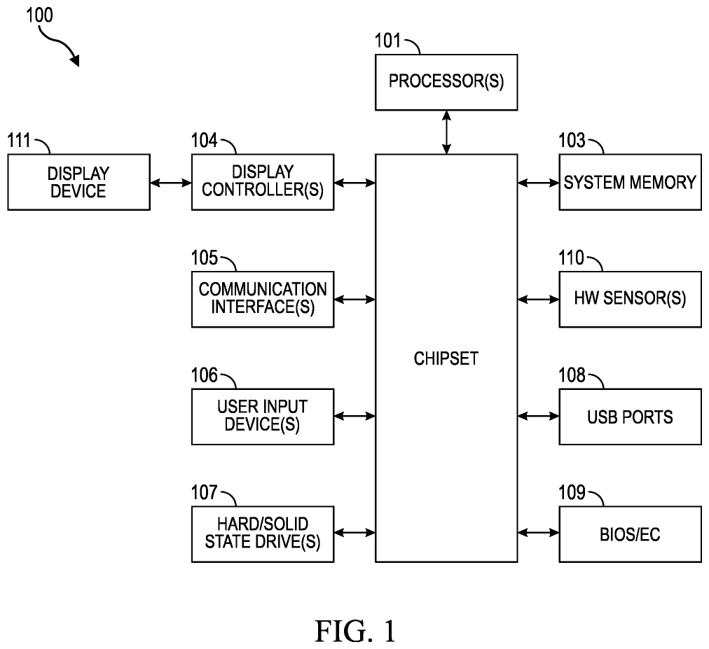

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

In modern enterprises, the term “hoteling” (or “office hoteling”), shared workspaces, or co-working spaces collectively refer to physical environments where clients, users, or employees can schedule their hourly, daily, or weekly use of individual spaces, such as office desks, cubicles, or conference rooms—thus serving as an alternative to conventional, permanently assigned seating. In some cases, hoteling clients, users, or employees access a reservation system to book an individual space (e.g., a desk, a cubicle, a conference room, an office, etc.) before they arrive at work, which gives them freedom and flexibility to work wherever they want to. In other cases, individual spaces may also be available to users without a reservation system on a first-come, first-serve basis (e.g., in the lobby of a hotel or in a library).

Each individual workspace may include its own set of peripheral devices (e.g., displays, webcams, microphones, speakers, headsets, printers, etc.). When a client, user, or employee reaches an individual workspace, they bring their own IHSs and choose between using peripheral devices integrated into their IHS or external peripheral devices found in that space.

As such, users typically connect to different peripheral devices each workday, particularly when executing collaboration applications, such as audio or video conferencing applications (e.g., ZOOM, TEAMS, etc.), or the like. For example, during a collaboration session, a user may employ a BLUETOOTH (BT) speaker with integrated microphone and webcams if in a home environment, a BT headset with an external webcam if in a cubicle environment, or a BT headset with integrated webcam when working from anywhere else. In different work environments, different combinations of peripheral devices may be available to the user.

In some cases, when a client, user, or employee arrives at a workspace, their IHS may be coupled to one or more peripheral devices via a Workspace Managing Device (WMD) such as a dock, docking station, intelligent hub, external display, wireless keyboard, video, and mouse (KVM) switch, or other IHS. Additionally, or alternatively, the IHS may be directly coupled to one or more peripheral devices using any suitable wireless communication protocol (e.g., BT, BT LOW ENERGY or “BLE,” ZIGBEE, Z-WAVE, WI-FI, WI-FI DIRECT, etc.). Additionally, or alternatively, a workspace may be served by one of a plurality of distributed Access Points (APs) for network/Internet connectivity, such as wireless routers or the like.

Although recommendation tools may exist to facilitate a user's selection of a workspace, for example, based upon their specific needs (e.g., an upcoming collaboration session requires a webcam), there is currently no mechanism available for recommending, to an IT administrator or decision maker (ITDM), how to re-configure or modify existing workspaces to accommodate their users' needs.

For example, consider a first hypothetical situation where an enterprise has multiple types of hybrid work cubicles. Cubicles of “type I” include a single monitor, a dock, and a keyboard/mouse, whereas cubicles of “type II” also include secondary monitors. In this scenario, users across the enterprise may not utilize both types of cubes in an equally distributed manner. Based upon their usage, type of users, and/or other telemetry data, an ITDM may wish to receive a recommendation to add, reduce, modify, or create cubicles of a certain type.

Now consider a second hypothetical where an enterprise supports remote work for their employees and provides one or more peripheral devices for a work-from-home space (i.e., a “home office setup”). Such work-from-home space may be different depending upon its user's type. For instance, an engineer may be issued a high-performance laptop and dock, a pair of displays, and a wired keyboard/mouse, whereas an executive may be issued a business-grade laptop, travel dock, a single monitor, wireless keyboard/mouse, and an external webcam. Based upon the usage, type of users, and/or other telemetry data, an ITDM may wish to receive a recommendation to add, reduce, modify, or create work-from-home spaces of a certain type.

In both hypotheticals, the ITDM may have originally distributed the available types of workspaces uniformly or based on arbitrarily selected factors (e.g., cost). Moreover, the ITDM's original workspace distribution may have been presumed to be static, which the inventors hereof have found to be detrimental to users' experiences.

To address these, and other concerns, systems and methods described herein may provide workspace distribution and/or configuration recommendations. In various embodiments, these systems and methods may provide a recommendation engine configured to instruct an ITDM to increase a number of, decrease a number of, modify, reconfigure, and/or create new types of workspaces in hybrid work environments to improve the return-on-investment (ROI) for the enterprise as well as with the users' experiences.

As such, techniques disclosed herein may enable the modeling, learning, and identifying of the best or most beneficial workspace distribution and/or configuration for a given purpose in a hybrid work environment. In some cases, these techniques may use Machine Learning (ML) or Artificial Intelligence (AI) models to receive workspace facility usage data, user profile, and/or device telemetry, to provide such distribution and/or configuration recommendations, and to implement at least a portion of the recommendations (e.g., by remotely changing the configuration of a docking station or peripheral device, instructing a docking station to couple or decouple a peripheral device, instructing the docking station to enable or disable a feature of a peripheral device coupled to it, etc.).

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BT, cellular or mobile networks (e.g., CDMA, TDMA, LTE, etc.), satellite networks, or the like. In some cases, communication interface(s) 105 may be used to communicate with devices (e.g., BT speakers, microphones, headsets, etc.). Moreover, communication interface(s) 105 may be coupled to chipset 102 via a PCIe bus.

Chipset 102 may be coupled to display controller(s) 104, which may include one or more or graphics processor(s) (GPUs) on a graphics bus, such as an Accelerated Graphics Port (AGP) or Peripheral Component Interconnect Express (PCIe) bus. As shown, display controller(s) 104 provide video or display signals to display device 111. In other implementations, any number of display controllers or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays.

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. Memory 103 may store program instructions that, upon execution by processor 101, enable a collaboration mode for a touchpad coupled or integrated into IHS 100.

Chipset 102 may also provide access to one or more hard disk and/or solid-state drives 107. In certain embodiments, chipset 102 may also provide access to one or more optical drives or other removable-media drives. In certain embodiments, chipset 102 may also provide access to one or more USB ports 108, to which one or more peripheral devices may be coupled (e.g., internal or external webcams, microphones, speakers, etc.).

Chipset 102 may further provide access to one or more user input devices 106, for example, using a super I/O controller or the like. Examples of user input devices 106 include, but are not limited to, a keyboard, mouse, touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105).

In certain embodiments, chipset 102 may also provide an interface for communications with one or more hardware (HW) sensors 110. Sensors 110 may be disposed on or within the chassis of IHS 100, and may include, but are not limited to: electric, magnetic, radio, optical, infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. BIOS 109 provides an abstraction layer that allows the OS to interface with certain hardware components that are utilized by IHS 100. Via the hardware abstraction layer provided by BIOS 109, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS 109 is intended to also encompass a UEFI component.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

In some implementations, a low-power mode of operation may include the S0 low-power idle model, also known as Modern Standby or Connected Standby, which provides an instant on/off user experience and maintains a network connection for certain processes while consuming very little power. These power modes may be entered, for example, when IHS 100 transitions into standby (e.g., “sleep,” etc.).

EC 109 may also implement operations for detecting certain changes to the physical configuration or posture of IHS 100 and managing the modes of a touchpad or other user input device 106 in different configurations of IHS 100. For instance, where IHS 100 as a 2-in-1 laptop/tablet form factor, EC 109 may receive inputs from a lid position or hinge angle sensor 110, and it may use those inputs to determine: whether the two sides of IHS 100 have been latched together to a closed position or a tablet position, the magnitude of a hinge or lid angle, etc.

EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component. Such hash values may be calculated as part of a trusted process of manufacturing IHS 100 and may be maintained in secure storage as a reference signature. EC 109 may later recalculate the hash value for a component may compare it against the reference hash value to determine if any modifications have been made to the component, thus indicating that the component has been compromised. In this manner, EC 109 may validate the integrity of hardware and software components installed on IHS 100.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip (SoC). As such, in certain embodiments, IHS 100 may be implemented as different classes of computing devices including, but not limited to: servers, workstations, desktops, laptops, appliances, video game consoles, tablets, smartphones, etc.

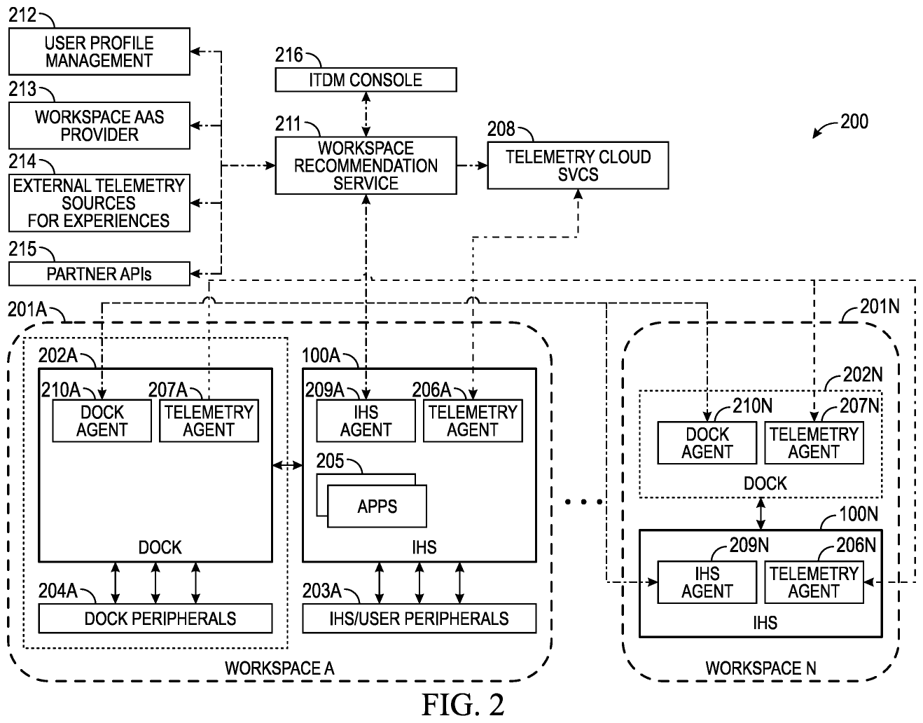

FIG. 2 depicts a block diagram of an example of system 200 for providing workspace distribution and/or configuration recommendations. In some embodiments, components of system 200 may be instantiated, at least in part, through the execution of program instructions stored in a memory device (e.g., system memory 103) by a processor (e.g., processor(s) 101) of one or more IHSs (e.g., IHS 100).

Particularly, as shown in FIG. 2, IHSs 100A-N may be disposed in respective ones of workspaces 201A-N (e.g., the user's home, a shared workspace, a cubicle, a desk, a conference room, a coffee shop, etc.) where docking stations (“docks”) 202A-N and peripheral devices 203A and 204A may be available. Examples of peripheral devices 203A and 204A include, but are not limited to: keyboards, mice, touchscreens, touchpads, trackpads, trackballs, pen tablets, joysticks, MIDI keyboards, scanners, cameras, microphones, biometric sensors, monitors, displays, projectors, TVs, printers, plotters, speakers, headsets, external hard drives, media card readers, digital camcorders, digital mixers, musical equipment, etc.

In this example, IHS 100A executes one or more applications 205 (e.g., a collaboration application, a text processor, a web browser, etc.). Each of IHSs 100A-N executes a respective one of IHS agents 209A-N and telemetry agents 206A-N. Also, each of docks 202A-N executes a respective one of dock agents 210A-N and telemetry agents 207A-N. IHS agents 209A-N and dock agents 210A-N are in communication with workspace recommendation service 211, and telemetry agents 206A-N and 207A-N are in communication with telemetry cloud service 208.

Each of IHS agents 209A-N and telemetry agents 206A-N may be executed as a background service and may be capable of running in Modern Standby. In various embodiments, each of IHS agents 209A-N may be configured to capture and share telemetry details (e.g., integrated and external peripheral usage and statistics, a user's unique ID, etc.) of their respective users and IHSs 100A-N, as collected by telemetry agents 206A-N, with workspace recommendation service 211. Conversely, each of dock agents 210A-N may be configured to capture and share telemetry details (e.g., connected IHS unique ID, dock peripheral usage and statistics, workspace/dock unique ID, etc.), as collected by telemetry agents 207A-N, with workspace recommendation service 211.

Workspace recommendation service 211 may be executed as a microservice hosted in the cloud that is interconnected with IT management console 216 (e.g., DELL TECHDIRECT, DELL ONEIT, etc.) and/or telemetry cloud services 208 (e.g., DELL DATAVAULT/INSIGHTS).

Upon initialization, workspace recommendation service 211 may use different Application Programming Interfaces (APIs) to establish sessions with: telemetry sources (e.g., telemetry cloud service 208), user profile data sources 212 (e.g., DELL ONIT's user profile database, etc.), workspace As-a-Service (AaS) manager 213 (e.g., APPSPACE, WORKINSYNC, INSPACE, etc.), experience telemetry providers 214 (e.g., ZOOM, TEAMS, etc.), and other partners 215 (e.g., WORKDAY, etc.). Additionally, or alternatively, workspace recommendation service 211 may establish sessions with IHS agents 209A-N and dock agents 210A-N.

In steady state operation, in addition to managing the sessions with internal and external telemetry providers, when any of IHS agents 209A-N establishes a session, workspace recommendation service 211 may also identify the connected user and their group/persona with the help of user profile data sources 212. Similarly, when any of dock agents 210A-N establishes a session, workspace recommendation service 211 may identify the connected workspace and its type with the help of workspace AaS manager 213. As such, workspace recommendation service 211 may maintain a collection of active workspaces (e.g., by type), and another collection of active users (e.g., by profile or group).

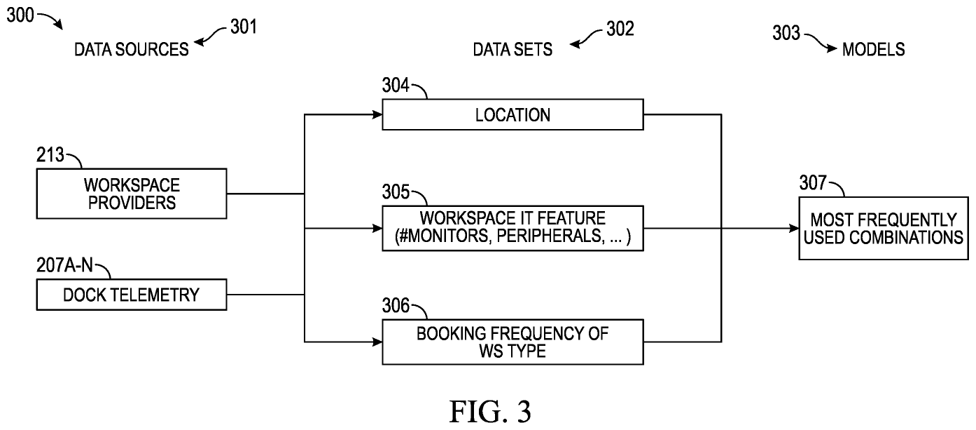

Based upon an ITDM's recommendation preference or optimization goals, workspace recommendation service 211 may execute any suitable recommendation method such as, for example, methods 300, 400, and 500 of FIGS. 3-5, using respective telemetry sources, to provide workspace distribution and/or configuration recommendations to the ITDM.

Examples of workspace data usable to generate recommendations include, but are not limited to, partner telemetry from hybrid workspace AaS provider 212 and smart dock telemetry, such as: workspace location (physical), workspace IT features (e.g., number of displays, sizes of displays, external cameras and types, keyboard and mouse details, etc.), workspace facilities features (e.g., desk type, chair type, cube type, proximity to other resources such as a shared printer, lighting conditions, quiet vs. collaborative space, etc.), booking frequency, booking interval times, booked by individual(s), group booking data (e.g., users, spaces, etc.), and so on.

Examples of user profile data usable to generate recommendations include, but are not limited to, user profile data from user profile management 212 and other partner services 215, such as: job title or job description, working hours preference, and collaborators (e.g., for booking in physical proximity).

Examples of experience telemetry data usable to generate recommendations include, but are not limited to, experience telemetry sources 214 and other partner services 215, such as: IHS model, IHS configuration, ports used, peripherals choice at home, peripherals preferred on campus, WiFi signal strength, inferred persona from telemetry, workload characterization (e.g., by performance requirements, etc.), and experience survey data (e.g., 5-star, Net Promoter Score or “NPS,” thumbs up/down, etc.).

Using data from these telemetry sources, workspace recommendation service 211 may recommend that the ITDM: (a) create more of a certain workspace type (e.g., create additional 20% of workspace Type “B”, which has two 1080p monitors and a USB printer); (b) add a specific peripheral to a selected workspace type (e.g., add a 4K webcam in all workspaces of Type “C”); or (c) create a new workspace type with a selected combination of peripherals.

As such, workspace recommendation service 211 may enable the ITDM to increase/decrease/modify/create new types of workspaces in a hybrid work environment, including shared workspaces and work-from-home spaces, to improve the overall ROI for the enterprise and the user experience.

In various embodiments, in order to generate workspace recommendations, workspace recommendation service 211 may implement a collaborative filtering and/or content-based filtering engine configured to execute ML/AI models or workloads including, but not limited to: regression workloads (e.g., Ordinary Least Squares Regression (OLSR), Linear Regression, Logistic Regression, Stepwise Regression, Multivariate Adaptive Regression Splines (MARS), Locally Estimated Scatterplot Smoothing (LOESS), etc.), instance-based workloads (e.g., k-Nearest Neighbor (kNN), Learning Vector Quantization (LVQ), Self-Organizing Map (SOM), Locally Weighted Learning (LWL), Support Vector Machines (SVM), etc.), regularization workloads (e.g., Ridge Regression, Least Absolute Shrinkage and Selection Operator (LASSO), Elastic Net, Least-Angle Regression (LARS), etc.), decision tree workloads (e.g., Classification and Regression Tree (CART), Iterative Dichotomizer 3 (ID3), C4.5 and C5.0, Chi-squared Automatic Interaction Detection (CHAID), Decision Stump, M5, Conditional Decision Trees, etc.), Bayesian workloads (e.g., Naive Bayes, Gaussian Naive Bayes, Multinomial Naive Bayes, Averaged One-Dependence Estimators (AODE), Bayesian Belief Network (BBN), Bayesian Network (BN), etc.), clustering workloads (e.g., k-Means, k-Medians, Expectation Maximization (EM), Hierarchical Clustering, Association Rule Learning Algorithms, etc.), association rule learning workloads (e.g., Apriori algorithm, Eclat algorithm, etc.), artificial neural network workloads (e.g., Perceptron, Multilayer Perceptrons (MLP), Back-Propagation, Stochastic Gradient Descent, Hopfield Network Radial Basis Function Network (RBFN), etc.), deep learning workloads (e.g., Convolutional Neural Network (CNN), Recurrent Neural Networks (RNNs), Long Short-Term Memory Networks (LSTMs), Stacked Auto-Encoders, Deep Boltzmann Machine (DBM), Deep Belief Networks (DBN), etc.), dimensionality reduction workloads (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), etc.), ensemble workloads (e.g., Boosting, Bootstrapped Aggregation (Bagging), AdaBoost, Weighted Average (Blending), Stacked Generalization (Stacking), Gradient Boosting Machines (GBM), Gradient Boosted Regression Trees (GBRT), Random Forest, etc.), etc.

FIG. 3 depicts a flowchart of an example of method 300 for providing workspace recommendations based upon usage. In some embodiments, method 300 may be performed, at least in part, by components of system 200 shown in FIG. 2. In method 300, workspace recommendation service 211 accesses data sources 301 to collect data sets 302 and applies models 303 to generate a workspace distribution and/or configuration recommendation.

Data sources 301 include workspace providers 213 and dock telemetry agents 207A-N, whereas data sets 302 include workspace location 304, workspace IT features 305 (e.g., # of monitors, peripheral devices, etc.), and booking frequency 306 of a workspace type. Using this combination of variables, method 300 may determine most frequently used combinations 307.

As such, in method 300, workspace recommendation service 211 tracks workspace type usage data—a combination of IT and facilities variables—and recommends frequently used combinations. For example, assume that in office location “A” employees frequently book workspace of type “X2,” and in office location “B” workspace of type “X3” is booked most often. In this scenario, a recommendation from method 300 may include increasing the number of workspaces of type “X2” in office location “A” and increasing the number of workspaces of type “X3” in location “B”.

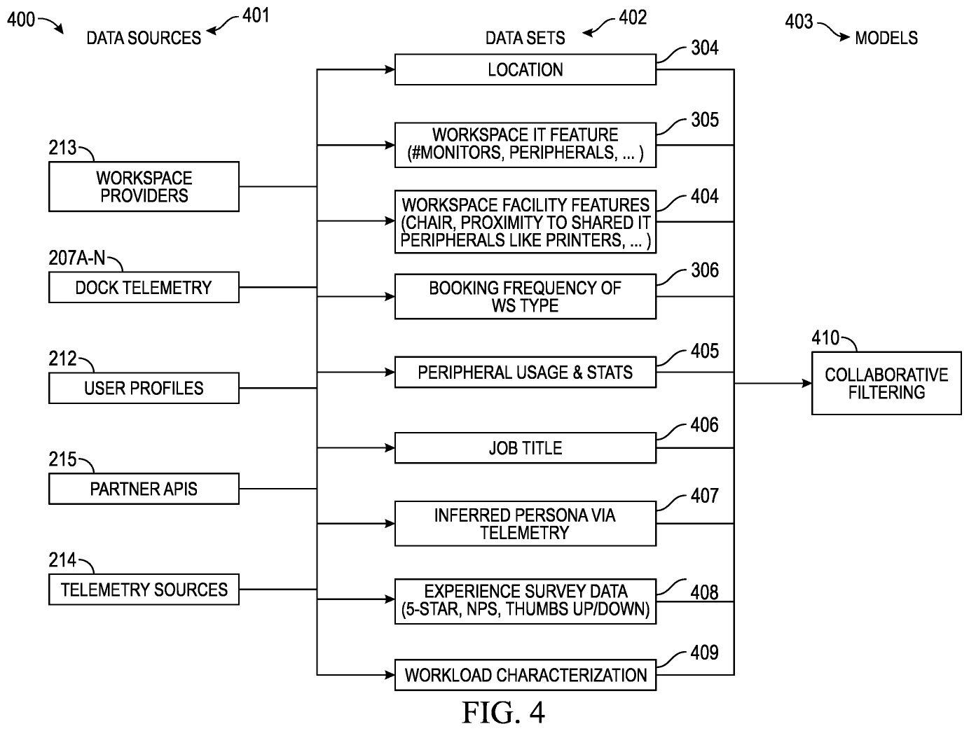

FIG. 4 depicts a flowchart of an example of method 400 for providing workspace recommendations based upon user personas and preferences. In some embodiments, method 400 may be performed, at least in part, by components of system 200 (in FIG. 2). In method 400, workspace recommendation service 211 accesses data sources 401 to collect data sets 402 and applies models 403 to generate a workspace distribution and/or configuration recommendation.

Data sources 401 include workspace providers 213, dock telemetry agents 207A-N, use profiles 212, telemetry sources 214, and other partner services 215. Data sets 402 include workspace location 304, workspace IT features 305 (e.g., # of monitors, peripheral devices, etc.), workspace facility features 404 (e.g., chair, proximity to shared resources, etc.), booking frequency 306 of the workspace type, peripheral usage and statistics 405, job title 406, inferred persona via telemetry 407, experience survey data 408, and workload characterization 409. Using this combination of variables, method 400 may employ collaborative filtering 410 as part of model 403 to determine workspace distribution and/or configuration recommendations based on user persona and preferences.

As such, in method 400, workspace recommendation service 211 connects workspace data with user profile and device telemetry data, mines IHS settings and peripheral choices made by users at primary workspaces (e.g., workspace at home), trains a model across IHS models, settings, and peripherals to find combinations that maximize user experience ratings, and uses workspace booking patterns and frequency data to prioritize the workspace(s) that match the primary workspace of the most frequent users. A recommendation in the form of a prioritized list may be provided to ITDMs for workspace planning.

For example, assume that among different user personas, a “power user” persona frequency uses workspace type “X4” along with a personal peripheral device (e.g., a webcam). In this scenario, a recommendation from method 400 may include upgrading all workspaces of type “X4” to include the peripheral device (e.g., the webcam). If the number of power users increases at a certain rate in a specific location, method 400 may also recommend that the ITDM increase the number of workspaces of type “X4” in that location.

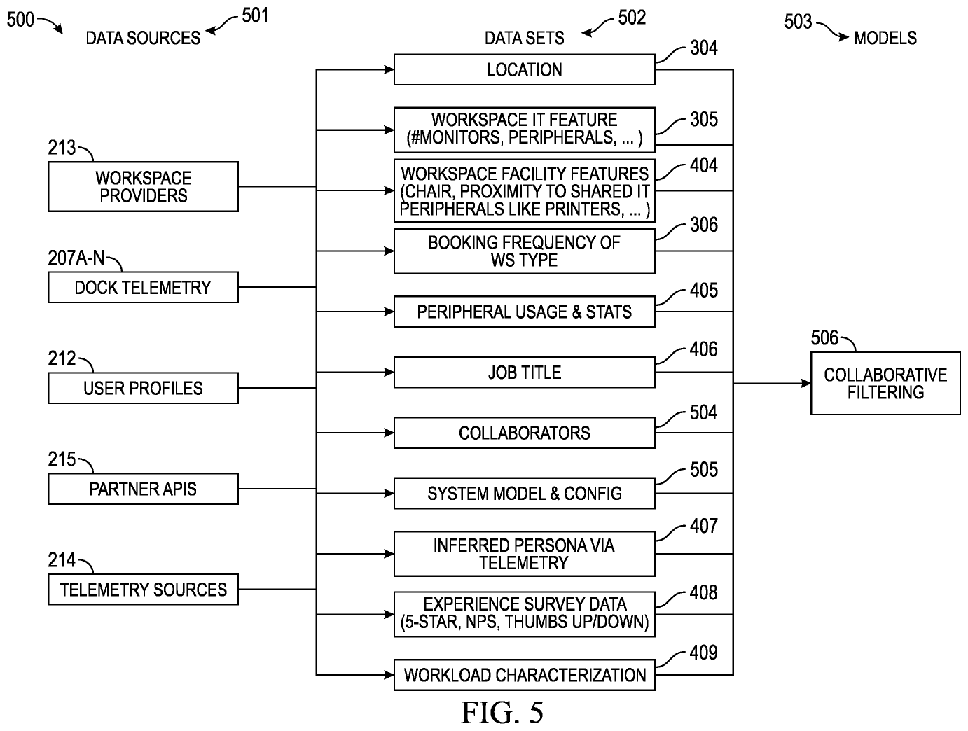

FIG. 5 depicts a flowchart of an example of method 500 for providing workspace recommendations based upon collaboration activities. In some embodiments, method 500 may be performed, at least in part, by components of system 200 shown in FIG. 2. In method 500, workspace recommendation service 211 accesses data sources 501 to collect data sets 502 and applies models 503 to generate a workspace distribution and/or configuration recommendation.

Data sources 501 and data sets 502 may include the same sources 401 and data sets 402 shown in FIG. 4. Data sets 502 further include collaborator information 504 and IHS model and configuration data 505. Using this combination of variables, method 500 may employ collaborative filtering 510 as part of model 503 to determine workspace distribution and/or configuration recommendations based on user persona and preferences.

As such, in method 500, workspace recommendation service 211 may use patterns and frequency of group booking data, as well as lists of frequent collaborators (e.g., from ZOOM, TEAMS, OUTLOOK, or other collaboration application telemetry), to distribute workspaces recommended for specific collaboration groups in physical proximity to each other. For example, assume that in a particular location, users A, B, and C attempt to group book a selected co-located workspace type, and that their booking failure rate is K % due to unavailability. In this scenario, a recommendation from method 500 may include increasing the number of workspaces of the selected type by K % with increased proximity to each other in that location.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a processor; and
a memory coupled to the processor, the memory having program instructions stored thereon that, upon execution, cause the IHS to:
receive data related to a plurality of workspaces;
generate, based upon the data, a recommendation to modify at least one of the plurality of workspaces; and
modify the at least one of the plurality of workspaces.

2. The IHS of claim 1, wherein each of the plurality of workspaces is selectable for use via a reservation service.

3. The IHS of claim 1, wherein the plurality of workspaces comprises at least one of: shared offices, share cubicles, shared desks, or work-from-home spaces.

4. The IHS of claim 1, wherein one or more workspaces among the plurality of workspaces comprises a docking station configured to receive a client IHS, and wherein the data comprises data obtained by the docking station.

5. The IHS of claim 1, wherein the data is received from one or more client IHSs with access to the plurality of workspaces.

6. The IHS of claim 1, wherein the data is received from at least one of: a workspace management system, a user profile database, a user experience telemetry service, or a human resources application.

7. The IHS of claim 1, wherein to generate the recommendation, the program instructions, upon execution, further cause the IHS to apply a Machine Learning (ML) or Artificial Intelligence (AI) model to the data.

8. The IHS of claim 7, wherein the ML or AI model comprises a collaborative filtering model.

9. The IHS of claim 1, wherein the recommendation comprises a recommendation to increase or decrease a number of workspaces of a selected type among the plurality of workspaces.

10. The IHS of claim 1, wherein the recommendation comprises a recommendation to add or remove a peripheral device to a selected type of workspace among the plurality of workspaces.

11. The IHS of claim 1, wherein the data comprises, for a given workspace among the plurality of workspaces, at least one of: an identity of the given workspace, a location of the given workspace, an identification of a docking station of the given workspace, an identification of a peripheral device coupled to a docking station of the given workspace, an identification of a peripheral device coupled to a client IHS in the given workspace, a number of displays in the given workspace, or a booking frequency of the given workspace.

12. The IHS of claim 11, wherein to generate the recommendation, the program instructions, upon execution, further cause the IHS to determine, based upon the data, that: (a) in a first location, a first type of workspace is used more than a second type of workspace, and (b) in a second location, the second type of workspace is used more than the first type of workspace, and wherein the recommendation comprises an indication to: (a) increase a number of workspaces of the first type in the first location, and (b) increase a number of workspaces of the second type in the second location.

13. The IHS of claim 1, wherein the data comprises, for a given workspace among the plurality of workspaces, at least one of: an identification of a seat in the given workspace, an identification of a desk in the given workspace, a proximity of the given workspace to a resource shared among two or more workspaces, a usage of the shared resource by the client IHS, an identify of a user of a client IHS in the given workspace, a job title of the user, a persona associated with the user, an experience metric of the user, or a workload executed by the user.

14. The IHS of claim 13, wherein to generate the recommendation, the program instructions, upon execution, further cause the IHS to determine, based upon the data, how to maintain an amount of workspaces of a certain type proportional to a number of users of a selected type by increasing or decreasing the amount.

15. The IHS of claim 1, wherein the data comprises, for a given workspace among the plurality of workspaces, an indication of a collaboration session involving the given workspace.

16. The IHS of claim 15, wherein to generate the recommendation, the program instructions, upon execution, further cause the IHS to increase a number of workspaces of a same type as the given workspace within a selected distance from the given workspace.

17. The IHS of claim 1, wherein to modify the at least one of the plurality of workspaces, the program instructions, upon execution, further cause the IHS to instruct a docking station in a given workspace to couple or decouple a peripheral device.

18. The IHS of claim 1, wherein to modify the at least one of the plurality of workspaces, the program instructions, upon execution, further cause the IHS to instruct a docking station in a given workspace to enable or disable a feature of a peripheral device.

19. A method, comprising:
generating, based upon telemetry data, a recommendation to modify at least one of a plurality of workspaces, wherein the telemetry data comprises at least one of: an identity of a given workspace among the plurality of workspaces, a location of the given workspace, an identification of a peripheral device coupled to a docking station of the given workspace, or a booking frequency of the given workspace; and
instructing the docking station to make the peripheral device, or a feature of the peripheral device, available or unavailable to a user of the given workspace based, at least in part, upon the recommendation.

20. A memory storage device having program instructions stored thereon that, upon execution by an Information Handling System (IHS), cause the IHS to:
receive data comprising at least one of: a proximity of a given workspace among a plurality of workspaces to a resource shared among two or more workspaces, or a usage of the shared resource; and
provide, based at least in part upon the data using a Machine Learning (ML) or Artificial Intelligence (AI) model, a recommendation to an Information Technology Decision Maker (ITDM) to increase or decrease a number of workspaces among the plurality of workspaces of a same type as the given workspace.
